(19) United States
(12) Patent Application Publication
(10) Pub. No.: US 2006/0181032 A1
(43) Pub. Date: Aug. 17, 2006

(54) Hybrid gasket

(76) Inventors: Robert Adam Riggs, Colonial Heights, VA (US); Alfred F. Waterland III, Chesterfield, VA (US)

Correspondence Address: John H. Thomas, P.C., 536 Granite Avenue, Richmond, VA, 23226, US

(21) Appl. No.: 11/056,614

(22) Filed: Feb. 11, 2005

(51) Int. Cl. F16J 15/08

(52) U.S. Cl. 277/627

(57) ABSTRACT

A hybrid gasket is constructed of first and second annular rings. The first annular ring is comprised of a polymer and includes a pocket therein that is defined by a slit that extends from the outside diameter of the first polymer ring toward the inside diameter. The second annular ring is comprised of a corrugated metal and is positioned inside the pocket of the first ring. The outside diameter of the first ring is greater than the outside diameter of the second ring.

The present invention relates to gaskets and particularly to hybrid gaskets constructed of polymers containing corrugated inserts.

### BACKGROUND OF THE INVENTION

Conventional polytetrafluoroethylene (PTFE) envelope gaskets use a machined PTFE envelope. These gaskets can be problematic because of their porosity and the propensity for the splitting of the thin PTFE envelope material. Additionally, the envelope may flare open prior to installation making the installation difficult. These conventional envelope gaskets also require high compressive stress/bolt load and have poor surface conformability. Other types of PTFE including expanded PTFE, full density PTFE and filled PTFE lack resiliency, so a corrugated insert may be used to provide this resiliency.

Gaskets having both polymer (PTFE) and metal components have been known and used for many years. These types of gaskets are acceptable for many gasket applications. The corrugated metal in combination with the polymer layers form a gasket able to handle low bolt load and thermal cycling and still maintain an adequate seal.

FIGS. 1 and 1A illustrate a conventional, prior art gasket having outside polymer rings 11 sandwiched around a corrugated metal ring insert 12. The polymer rings 11 and metal ring 12 are attached to each other through use of adhesive 13 on each side of the metal ring. As shown in the drawings, this sandwich-type construction means that all of the layers of the gasket, including the metal and adhesive layers 12 and 13, are exposed at the inside diameter 15 and outside diameter 16 of the gasket 10. Problems with these types of gaskets include corrosion or degradation of the various levels of the gasket that may occur as a result of the exposure of the metal and/or adhesive to the process temperature and media in the system in which the gasket 10 is used. (For instance, temperatures in excess of 250° may degrade an adhesive.) Over time, as the adhesive 13 is corroded away, the gasket seal may fail or require re-torquing as a result of the reduced bulk of the gasket 10. Prior art designs require the use of metal inserts that are chemically compatible with the process being sealed. For many corrosive chemical applications where the tightness and resiliency of the gasket are required, exotic alloy inserts such as hastalloy, titanium, and other similar products are required. The resulting gaskets are very expensive and may still suffer from thermal degradation or other corrosion of the adhesive layers.

FIGS. 2 and 2A illustrate another prior art gasket 2D. In this construction, gasket 20 includes a single polymer ring 21 that has a slit in it that extends from the outside diameter 26 toward the inside diameter 25 that does not extend all the way through the polymer ring. A metal insert 22 is positioned in a pocket formed by the slit of the polymer ring 21, has an outside diameter essentially the same as the polymer ring, and is secured there by adhesive layers 23 on each side of the metal insert. This construction, therefore, results in a gasket 20 having a solid inside diameter 25 that when properly designed to achieve the correct flange compression (or gasket stress) during assembly does not expose the metal insert 22 or adhesive 23 at the inside diameter of the gasket. However, general conditions in a plant or system where the gasket 20 is used may still attack or thermally degrade the adhesive 23 and/or metal insert 22 from the outside diameter 26. As the adhesive 23 is reduced/degraded or corroded away, the load on the gasket is reduced and the gasket may become loose and lose its seal. Also, the exposure of the metal insert 22 at the outside diameter 26 will cause problems in polymer lined or plastic piping systems when static electricity builds up in the metal insert. A significant electric charge may develop in the metal insert 22 that can discharge. This electric charge may make the system difficult for worker to operate around the system. Dangerous sparks may result which can ignite product leaking past the gasket that has been thermally or chemically degraded as discussed earlier.

### SUMMARY

Accordingly, it is an object of the present invention to overcome the foregoing drawbacks and provide an effective hybrid gasket construction. The new construction provides nonconductive polymer elements at both the inside diameter and outside diameter of a gasket, thereby encapsulating a rigid, typically metal insert and removing the need for adhesive to adhere to and hold a metal insert in place inside a gasket.

In one example, a hybrid gasket comprises a first annular ring comprising a polymer. The first ring has an inside diameter and an outside diameter, wherein the width of the first ring is the radial distance from the inside diameter to the outside diameter, and wherein the first ring has a thickness that is the distance from one side of the ring to the opposite side. The first annular ring has a pocket therein that is defined by a slit from the outside diameter of the first ring toward the inside diameter, and wherein the radial width of the slit is less than the width of the first ring. A second annular ring is comprised of a corrugated metal. The second ring has an inside diameter and an outside diameter, wherein the width of the second ring is the radial distance from the inside diameter to the outside diameter, and wherein the width of the second ring is less than the width of the first ring. The second ring is positioned inside the pocket of the first ring. And the outside diameter of the first ring is greater than the outside diameter of the second ring. The gasket may further comprise adhesive applied to the inside of the pocket and outside the outside diameter of the second ring, whereby the second ring is sealed within the thickness of the first ring. The hybrid gasket may also further include a third annular ring having an inside diameter greater than the outside diameter of the second ring, and the inside diameter is less than the outside diameter of the first ring. The third annular ring is positioned, at least in part, inside the pocket of the first ring. Adhesive may be applied to both sides of the third annular ring to seal the third annular ring inside the pocket. The first annular ring may be comprised of expanded polytetrafluoroethylene. The width of the slit may be substantially equal to the width of the second ring plus the width of the third ring.

### BRIEF DESCRIPTION OF THE DRAWINGS

FIGS. 1 and 1A are perspective and side cross-sectional views respectively of one example of a prior art gasket.

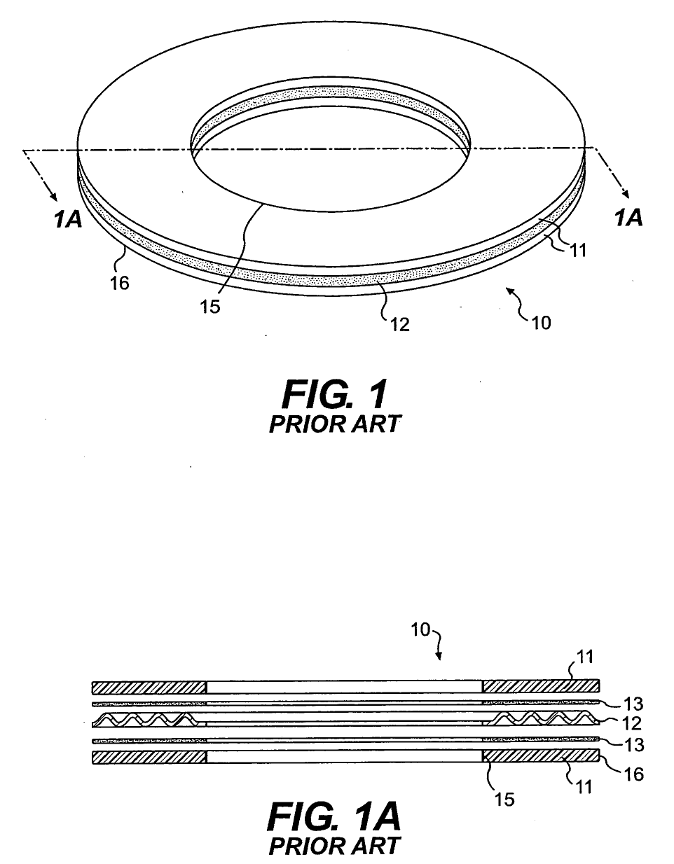

FIGS. 2 and 2A are perspective and side cross-sectional views of a second example of a prior art gasket.

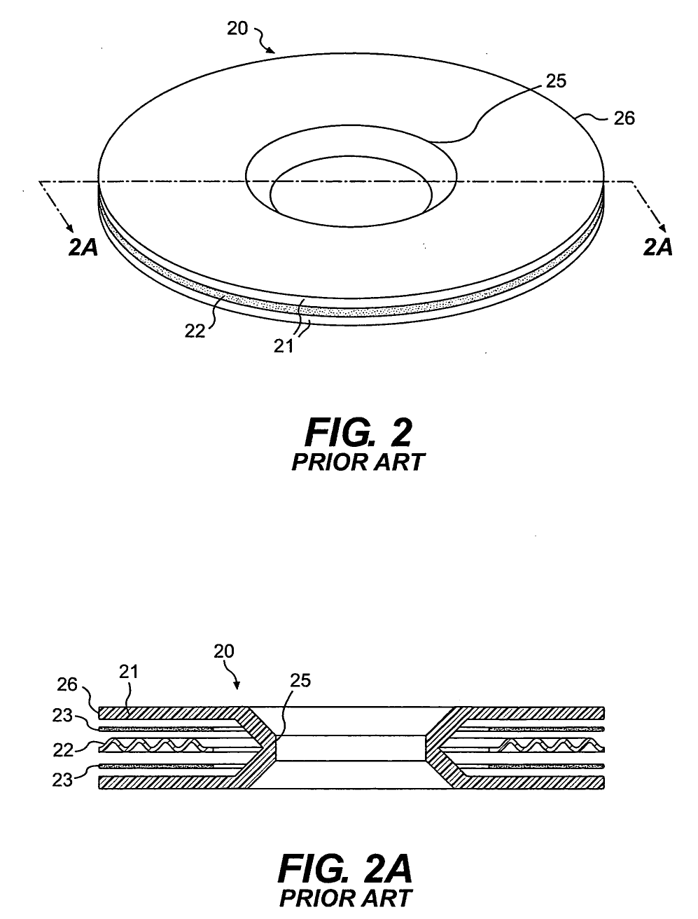

FIGS. 3 and 3A are perspective and side cross-sectional views of one example of a hybrid gasket described herein.

FIGS. 4A and 4B are an exploded view and side cross-sectional view respectively of another example of a gasket as described herein.

### DETAILED DESCRIPTION

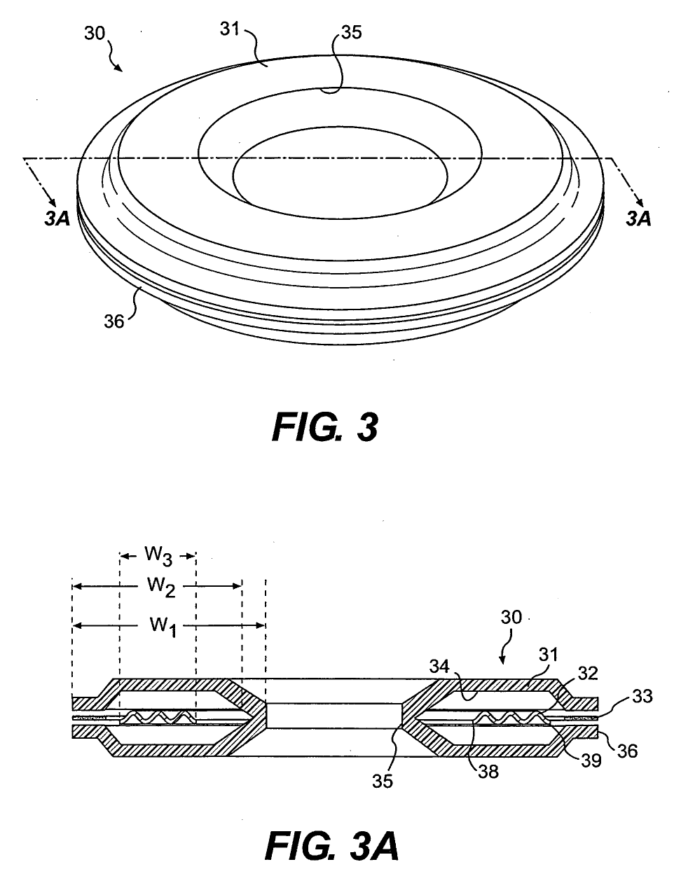

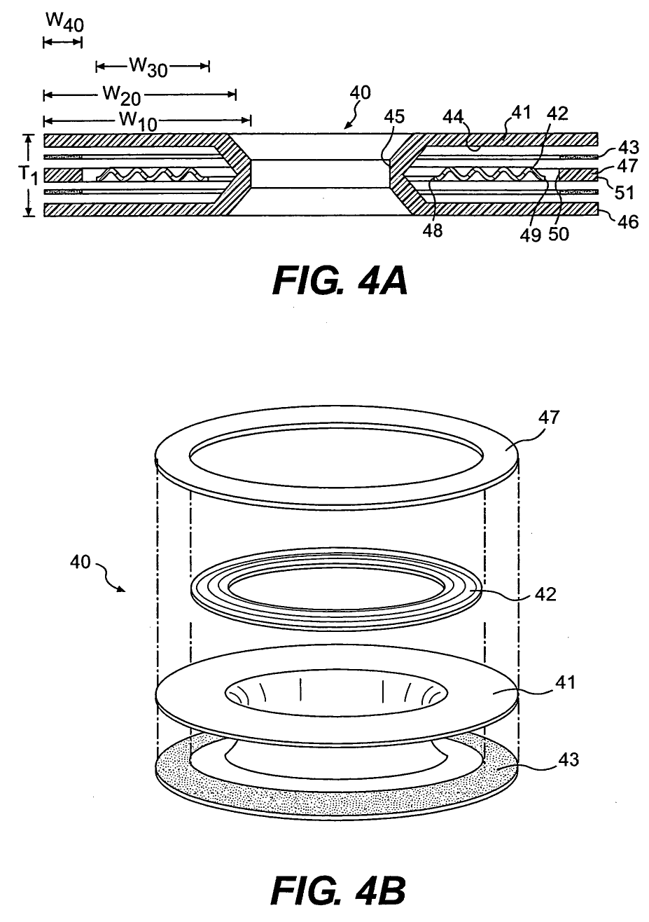

The present invention is demonstrated in FIGS. 3, 3A, 4, and 4A. In each example, a pocket is created in a polymer ring for positioning of a corrugated insert therein. The pocket maintains intact and seamless the inside diameter of the gasket. The outside diameter is sealed by adhesive either with or without an additional ring of polymer or other nonconductive material. The result is a hybrid gasket of a corrugated insert and polymer wherein the insert component is effectively insulated from interior and exterior chemical attack and further the effective sealing portion of the gasket is comprised of only polymer material and corrugated insert material—there is no adhesive to degrade and lose thickness, thereby resulting in reduced bolt load. Of course, other variations could be developed by those with skill in the art based on the teachings herein. Those additional alternative constructions are encompassed by the scope of the claims herein.

Referring now to FIGS. 3 and 3A, there is shown a gasket 30 that includes a first annual ring 31 formed from a polymer material. The ring 31 has a width W1 that is defined by the radial distance from the inside diameter 35 to the outside diameter 36 of the polymer ring 31. The polymer ring 31 has a pocket 34 therein that is defined by a slit from the outside diameter 36 toward the inside diameter 35. Importantly, the slit that forms the pocket 34 does not extend all the way from the outside diameter 36 to the inside diameter 35. In this way, the inside diameter 35 of the gasket 30 is solid polymer formed from the polymer ring 31. In other words, the width W2 of the pocket 34 is less than the width W1 of the polymer ring 31.

The gasket 30 includes a second annular ring 32 formed of a corrugated material, typically metal. The metal ring 32 has an inside diameter 38 and outside diameter 39, and the width W3 of the second ring 32 is the radial distance from the inside diameter 38 to the outside diameter 39. The width W3 of the second ring 32 is less than the width W1 of the first ring 31. The corrugated ring 32 is positioned inside the pocket 34 of the first ring 31. A layer of adhesive 33 is applied to the inside of the pocket 34 on the portion of the pocket that is outside the outside diameter 39 of the metal ring 32. The adhesive 33 seals together the polymer ring 31, thereby encapsulating the metal ring 32 inside the pocket 34.

FIGS. 4 and 4A illustrate a gasket 40 that is comprised of a first annular ring 41 made from a polymer material. The polymer ring 41 has an inside diameter 45 and outside diameter 46 that define width W10. The thickness of the polymer ring 41 is the distance from one side of the ring to the other, opposite side, and is shown as T1. The polymer ring 41 has a pocket 44 therein that is defined by a slit inside the thickness T1 and from the outside diameter 46 toward, but not all the way to, the inside diameter 45. The pocket 44 is only open at the outside diameter 46. The radial width W20 of the pocket 44 is less than the width W10 of the polymer ring 41.

A corrugated metal ring 42 has an inside diameter 48 and an outside diameter 49 that define width W30 that is the radial distance from the inside diameter to the outside diameter. The width W30 of the metal ring 42 is less than the width W10 of the first ring 41. The metal ring 42 is positioned inside the pocket 44 of the first ring 41. Also, the outside diameter 46 of the first ring 41 is greater than the outside diameter 49 of the metal ring 42.

The gasket 40 further includes a polymer third ring 47 having inside diameter 50 and an outside diameter 51. The width W40 is the radial distance from the inside diameter 50 to the outside diameter 51 of the polymer ring 47. The inside diameter 50 of the polymer ring 47 is greater than the outside diameter 49 of the metal ring 42. The outside diameter 51 of the polymer ring 47 as shown is substantially equal to or less than the outside diameter 46 of the first ring 41. (The outside diameter 51 could also be greater than the outside diameter 46 of the first ring 41.) The polymer ring 47 is positioned inside the pocket 44. Adhesive 33 is applied to both sides of the ring 47 to secure it inside the pocket 44. Importantly, the adhesive 43 is applied inside the pocket 44 but outside the outside diameter 49 of the second ring 42.

In one application, the inside and outside diameters 48 and 49 respectively of the corrugated insert 42 are engineered with the inside diameter of the third polymer ring 47 so that adhesive 43 and the third ring itself are not compressed by the flange loading faces in the given joint. Carrying no load, therefore, the thermal degradation of the adhesive does not impact the portion of the gasket that is compressed and sealing. In other words, the outside diameter 49 of the corrugated insert 42 is engineered to be substantially the same as the outside diameter of a pipe flange raised face so that the third ring 47 (and adhesive 43) do not have any sealing role.

The polymers or envelope materials that may be used in connection with the components of the gasket described herein may be any form of polytetrafluoroethylene (PTFE) or other material used in the gasket industry including, but not limited to, the following: elastomers, PTFE, porous PTFE, expanded PTFE, filled PTFE, microcellular PTFE, expanded graphite, etc. The use of PTFE in various forms is often advantageous, because PTFE is chemically inert to most process media, and it is electrically nonconductive.

The corrugated insert may be any rigid material, typically metal. Commonly used metal inserts are made from stainless steel, carbon steel, copper, copper alloy, nickel alloy, titanium alloy, hastalloy, etc. Rigid plastics or polymers may also be used. The thickness of the insert and amount of corrugation will depend on gasket size and specific application requirements, as will the inside diameter/outside diameter of all components within the gasket.

The components of the gasket may be secured together using adhesives or other means of securing including heat fusion (e.g. expanded PTFE) or FEP/PFA melt films or mechanical compression or stitching. Different adhesives that may be used in connection with the present gasket are known to those in the gasket industry including, but not limited to, pressure sensitive adhesives, epoxy, acrylic, rubber, etc. It is preferable to use adhesives that are relatively inert or minimally affected by process or atmospheric conditions within the plant environment.

While the invention has been described with reference to specific embodiments thereof, it will be understood that numerous variations, modifications and additional embodiments are possible, and all such variations, modifications, and embodiments are to be regarded as being within the spirit and scope of the invention.

What is claimed is:

1. A hybrid gasket comprising:
a first annular ring comprising a polymer, the first ring having an inside diameter and an outside diameter, wherein the width of the first ring is the radial distance from the inside diameter to the outside diameter, and wherein the first ring has a thickness that is the distance from one side of the ring to the opposite side;
wherein the first annular ring has a pocket therein that is defined by a slit from the outside diameter of the first ring toward the inside diameter, and wherein the radial width of the slit is less than the width of the first ring;
a second annular ring comprising a corrugated metal, the second ring having an inside diameter and an outside diameter, wherein the width of the second ring is the radial distance from the inside diameter to the outside diameter, and wherein the width of the second ring is less that the width of the first ring;
wherein the second ring is positioned inside the pocket of the first ring; and
wherein the outside diameter of the first ring is greater that the outside diameter of the second ring.

2. A hybrid gasket as described in claim 1, further comprising adhesive applied inside the pocket and outside the outside diameter of the second ring,
whereby the second ring is sealed within the thickness of the first ring.

3. A hybrid gasket as described in claim 1, further comprising a third annular ring having an inside diameter greater than the outside diameter of the second ring, and the inside diameter is less than the outside diameter of the first ring;
wherein the third annular ring is positioned, at least in part, inside the pocket of the first ring.

4. A hybrid gasket as described in claim 3, further comprising adhesive applied to both sides of the third annular ring to seal the third annular ring inside the pocket.

5. A hybrid gasket as described in claim 5, wherein the first annular ring is comprised of expanded polytetrafluoroethylene.

6. A hybrid gasket as described in claim 1, wherein the first annular ring is comprised of a polymer selected from the group consisting of PTFE, porous PTFE, expanded PTFE, filled PTFE, and microcellular PTFE.

7. A hybrid gasket as described in claim 1, wherein the second annular ring is comprised of a metal selected from the group consisting of stainless steel, carbon steel, copper alloy, nickel alloy, titanium alloy and hastalloy.

8. A hybrid gasket as described in claim 3, wherein the second annular ring is comprised of a metal selected from the group consisting of stainless steel, carbon steel, copper alloy, nickel alloy, titanium alloy and hastalloy.

9. A hybrid gasket as described in claim 3, wherein the width of the slit is substantially equal to the width of the second ring plus the width of the third ring.

10. A hybrid gasket as described in claim 3, wherein the third annular ring is comprised of a polymer selected from the group consisting of PTFE, porous PTFE, expanded PTFE, filled PTFE, and microcellular PTFE.
